(19) United States
(12) Patent Application Publication
(10) Pub. No.: US 2010/0269714 A1
(43) Pub. Date: Oct. 28, 2010

(54) DOUBLE-SIDE DEFROST TRAY

(75) Inventor: Yang ZHOU, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/766,087

(22) Filed: Apr. 23, 2010

(30) Foreign Application Priority Data
Apr. 23, 2009 (CN) 200920137960.7

(51) Int. Cl. A23L 3/36

(52) U.S. Cl. 99/485

(57) ABSTRACT

A double-side defrost tray has an upper defrost tray, a lower defrost tray and a lifting rod unit. One end of the lifting rod unit is hinged with two ends of the rear side of the lower defrost tray, while the other end of the lifting rod unit is hinged with the two sides of the upper defrost tray. The relative rotation of the lifting rod unit drives the upper defrost tray to move horizontally. The food can be clamped between the upper defrost tray and the lower defrost tray so that both sides of the food can be simultaneously defrosted. The upper defrost tray can be horizontally lifted relative to the lower defrost tray, so the distance between the upper and lower defrost tray can be adjusted in the present invention according to the thickness of the food.

### FIELD OF THE INVENTION

The present invention relates to a defrost device.

### BACKGROUND OF THE INVENTION

The conventional defrost tray is usually designed as a single layer, it is too slow to defreeze the food, and the amount of the frozen food which is prepared to be defrozen is limited. Moreover, it is inconvenient to assemble the water from the defrozen food, the water will flow everywhere, thus it bothers the user to do more cleansing after defreezing.

CN2241443 published a defrozening board for frozen food, wherein a plurality of bar-shaped grooves are arranged on the upper surface of the defrozening board made of metal, and a plurality of bar-shaped bulges are arranged on the lower surface of the defrozening board simultaneously, said defrozening board is single layer, it only can defreeze food on one side, so the defreezing efficiency is relatively low.

CN2240324 published a structure promoted defreezing tray, it comprises a containing tray and an unfreezing tray, the containing tray is an inner concave-shaped entity and is used to contain the water after unfreezing, a placing part with appropriate width and thickness is extended from the inner side of the entity to the outside, a handle used for gripping and moving is arranged on the circumference of the entity, the placing part is a containing unfreezing tray which is an entity for placing the unfreezing articles, a plurality of ring-shaped concave grooves are circularly arranged on the top of the entity, and through holes are arranged on the concave grooves, the spilled water of frozen articles in the process of unfreezing can flow into the containing tray through the concave grooves and the through holes. The containing tray and unfreezing tray are separate structures, it is inconvenient to operate, and it can only defreeze food on one side, thereby the defreezing efficiency is relatively low.

### SUMMARY OF THE INVENTION

The main objective of the present invention is to overcome the shortages of the conventional technique, it provides a double-side defrost tray which can simultaneously defreeze the food on double sides, it will greatly increase the defreezing efficiency of the frozen food.

The technical solution applied by the present invention is:

A defrost tray comprises an upper defrost tray, a lower defrost tray and a lifting rod unit; said upper defrost tray and lower defrost tray are connected by said lifting rod unit; one end of said lifting rod unit is hinged with the two ends of rear side of said lower defrost tray, the other end of said lifting rod unit is hinged with the two sides of said upper defrost tray; the relative rotation of said lifting rod unit drives said upper defrost tray move horizontally.

According to a preferred embodiment of the present invention, the bottom surface of said lower defrost tray has supporting legs.

According to a preferred embodiment of the present invention, the central parts of the two sides of said upper defrost tray respectively protrude upwardly and disposed with hinge shelves

According to a preferred embodiment of the present invention, a stopper is disposed on the hinge position of said lower defrost tray and said lifting rod unit and when said upper defrost tray rotate relative to said lower defrost tray with 180 degrees, said stopper will lean against the bottom surface of said upper defrost tray and cooperate with said hinge shelves to make said upper defrost tray horizontally positioned.

According to a preferred embodiment of the present invention, the upper surface of said lower defrost tray has plural water tanks; said water tanks collect water into a water reservoir which is disposed on said lower defrost tray.

According to a preferred embodiment of the present invention, the bottom surface of said water tank is inclined.

According to a preferred embodiment of the present invention, the lower surface of said upper defrost tray has plural water tanks, said water tanks collect water into a water reservoir which is disposed on said upper defrost tray.

According to the above description of the present invention, the bottom surface of said water tank is inclined.

Firstly, the present invention has an upper defrost tray and a lower defrost tray, the frozen food can be clamped between them, so the double sides of the food can be defrozen simultaneously, so it will greatly increases the defreezing speed.

Secondly, the upper defrost tray and lower defrost tray are connected by lifting rods, so the upper defrost tray can be horizontally lifted relative to the lower defrost tray, so the distance between the upper and lower defrost tray can be adjusted in the present invention according to the different thickness of the food, so the upper defrost tray can contact the frozen food which is prepared to be defrozen as closer as possible, the defreezing efficiency will be promoted.

Thirdly, the upper defrost tray can rotate relative to the lower defrost tray with 180 degrees, so the upper defrost tray can contain the frozen food which is prepared to be defrozen by itself. When there is a lot of the frozen food which is prepared to be defrozen, the upper and lower defrost tray can respectively and simultaneously defreeze the frozen food, thus the amount of the frozen food which is prepared to be defrozen can be increased.

Fourthly, plural water tanks are arranged on the surface of the defrost tray, said water tanks collect water into the water reservoir which is disposed on the defrost tray, so the water from the defrozen food can be collected into the water reservoir instead of spilling to the operation platform, it won't bother the user to do a lot of cleansing after defreezing.

Fifthly, the central parts of the two sides of the upper defrost tray are respectively protrude upwardly and disposed with hinge shelves, two lifting rods are respectively hinged with the two hinge shelves, further a stopper is disposed on the hinge position of the lower defrost tray and the lifting rods, when the upper defrost tray rotate relative to the lower defrost tray with 180 degrees, said stopper will lean against the bottom surface of said upper defrost tray and cooperate with the hinge shelves to make the upper defrost tray horizontally positioned, thereby the upper defrost tray will be kept steady after unfolding.

Sixthly, the bottom surface of said water tank is inclined, so the water from the defrozen food will flow into the water reservoir more fluently, it is convenient to do the following job.

### BRIEF DESCRIPTION OF THE DRAWINGS

FIG. 1 is the perspective structural view of the preferred embodiment of the present invention.

FIG. 2 is the unfolded structural view of the preferred embodiment of the present invention.

FIG. 3 is the structural view of the lower defrost tray of the preferred embodiment of the present invention.

FIG. 4 is the side structural view of the assembling a kind of frozen food which is prepared to be defrozen of the preferred embodiment of the present invention.

FIG. 5 is the side structural view of the assembling another kind of frozen food which is prepared to be defrozen of the preferred embodiment of the present invention.

FIG. 6 is the sectional structural view of the lower defrost tray of the preferred embodiment of the present invention.

### DETAILED DESCRIPTION OF THE EMBODIMENTS

The present invention will be fully explained by the description of the preferred embodiment.

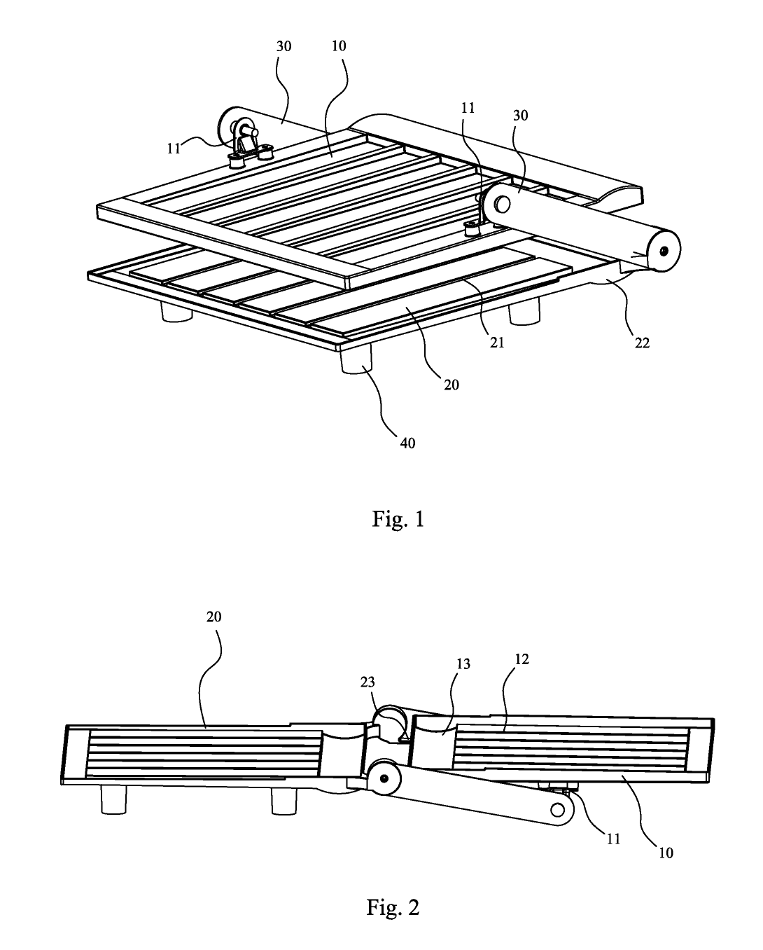

Please refer to FIG. 1, the double-side defrost tray of the present invention comprises an upper defrost tray 10 and a lower defrost tray 20, they are connected by two lifting rods 30, an end of said two lifting rods 30 are respectively hinged with the two ends of a side of said lower defrost tray 20, another end of said two lifting rods 30 are respectively hinged with the two hinge shelves 11 which are protrude upwardly on the upper surface of the upper defrost tray 10.

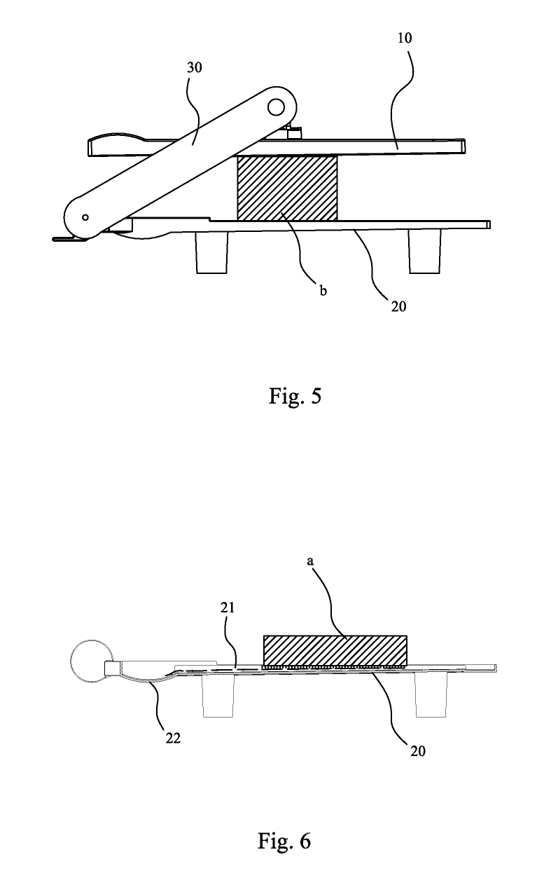

Please refer to FIG. 1\FIG. 4 and FIG. 5, the relative rotation of the two lifting rods 30 and the upper defrost tray 10 and the relative rotation of the two lifting rods 30 and the lower defrost tray 20 drive the upper defrost tray 10 to be horizontally lifted, so the upper defrost tray 10 and the lower defrost tray 20 are kept parallel. Please refer to FIG. 4, a relative thin food a which is prepared to be defrozen is arranged between the upper defrost tray 10 and the lower defrost tray 20; please refer to FIG. 5, when a relative thick food b is needed to be clamped between the upper defrost tray 10 and lower defrost tray 20, firstly lift the upper defrost tray 10, then the upper defrost tray 10 and the lower defrost tray 20 will simultaneously rotate relative to the two lifting rods 30, so the upper defrost tray 10 will be horizontally lifted, the food b will be clamped between the upper defrost tray 10 and the lower defrost tray 20, and the upper defrost tray 10 and the lower edefrost tray 20 will simultaneously fully contact with the double sides of the food b.

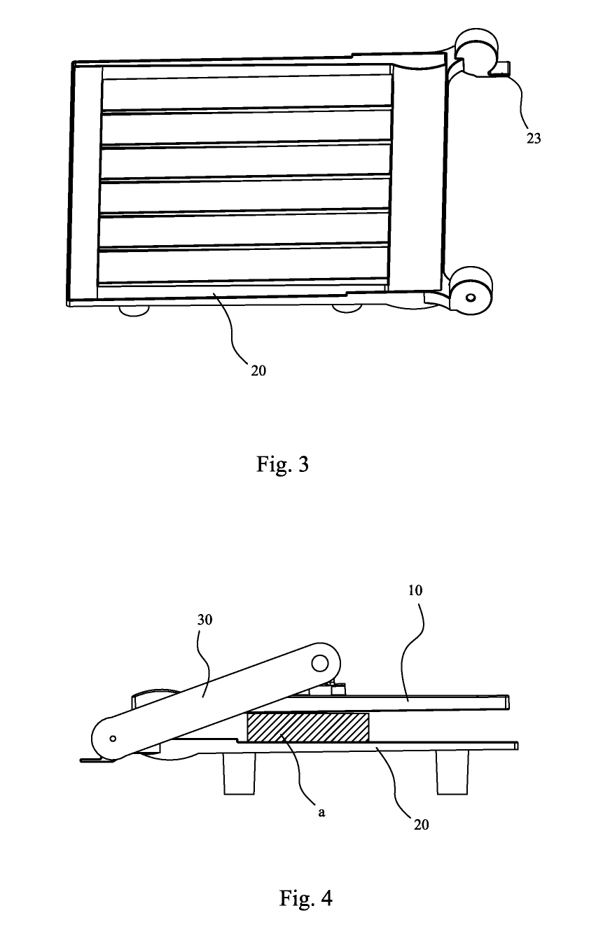

Please refer to FIG. 1\FIG. 2 and FIG. 3, a stopper 23 is arranged on one side of the hinge position of the lower defrost tray 20 and the lifting rod 30, when the upper defrost tray 10 rotate relative to the lower defrost tray 20 with 180 degrees, the stopper will lean against the bottom surface of the top defrost tray 10 and cooperate with the two hinge shelves 11 to support the top defrost tray 10 and keep it horizontally positioned. Besides, in order to ensure the upper defrost tray 10 keeps horizontally positioned when it is unfolded, the disposing of the hinge shelves 11 must ensure the center of gravity of the unfolded upper defrost tray 10 to be arranged between the stopper 23 and the hinge shelves 11.

Please refer to FIG. 1 and FIG. 6, a plurality of small water tanks 21 are disposed on the upper surface of the lower defrost tray 20, said small water tanks 21 communicate with the water reservoir 22 on one side of the lower defrost tray 20, the bottom surface of the water tanks are inclined, so the water from the defrozen food will flow from the small water tanks 21 and to be collected into the water reservoir; please refer to FIG. 2, the upper surface of the upper defrost tray 10 has a plurality of small water tanks 12, said small water tanks 12 communicate with the water reservoir 13 on one side of the upper defrost tray 10, the bottom surface of the water tanks are inclined, so the water from the defrozen food will flow from the small water tanks 12 and to be collected into the water reservoir 13. In the present invention, it dispose the small water tanks and water reservoirs on the upper defrost tray 10 and the lower defrost tray 20, so the following job will be more laborsaving.

Please refer to FIG. 1, the bottom surface of the lower defrost tray 20 has supporting legs 40.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

What is claimed is:

1. A defrost tray comprises an upper defrost tray, a lower defrost tray and a lifting rod unit; wherein said upper defrost tray and lower defrost tray are connected by said lifting rod unit; one end of said lifting rod unit is hinged with the two ends of rear side of said lower defrost tray, the other end of said lifting rod unit is hinged with the two sides of said upper defrost tray; the relative rotation of said lifting rod unit drives said upper defrost tray move horizontally.

2. The defrost tray according to claim 1, wherein the bottom surface of said lower defrost tray has supporting legs.

3. The defrost tray according to claim 1, wherein the central parts of the two sides of said upper defrost tray respectively protrude upwardly and disposed with hinge shelves, said lifting rod unit is hinged with said two hinge shelves.

4. The defrost tray according to claim 3, wherein a stopper is disposed on the hinge position of said lower defrost tray and said lifting rod unit and when said upper defrost tray rotate relative to said lower defrost tray with 180 degrees, said stopper will lean against the bottom surface of said upper defrost tray and cooperate with said hinge shelves to make said upper defrost tray horizontally positioned.

5. The defrost tray according to claim 1, wherein the upper surface of said lower defrost tray has plural water tanks; said water tanks collect water into a water reservoir which is disposed on said lower defrost tray.

6. The defrost tray according to claim 5, wherein the bottom surface of said water tank is inclined.

7. The defrost tray according to claim 1, wherein the lower surface of said upper defrost tray has plural water tanks, said water tanks collect water into a water reservoir which is disposed on said upper defrost tray.

8. The defrost tray according to claim 7, wherein the bottom surface of said water tank is inclined.
